(19) United States
(12) Patent Application Publication
(10) Pub. No.: US 2021/0373793 A1
(43) Pub. Date: Dec. 2, 2021

(54) Data self-destruction method and system based on non-volatile memory

(71) Applicant: SHANDONG UNIVERSITY, Jinan (CN)

(72) Inventors: Jiezhi CHEN, Jinan (CN); Rui CAO, Jinan (CN); Yuxin GONG, Jinan (CN); Wenjing YANG, Jinan (CN)

(21) Appl. No.: 16/341,877

(22) PCT Filed: Sep. 7, 2018
(86) PCT No.: PCT/CN2018/104545

§ 371 Date: Apr. 12, 2019

(30) Foreign Application Priority Data
May 25, 2018 (CN) 201810515439.6

(51) Int. Cl. G06F 3/06

(52) U.S. Cl. CPC G06F 3/0652; G06F 3/0604; G06F 3/0679

(57) ABSTRACT

Disclosed is a data self-destructing method and system based on a non-volatile memory. The method comprises: partitioning a memory module into different storage areas; causing the data to be self-destructed within a specific hold time in different areas; or dynamically selecting a read/write manner for each storage area so as to perform different read/write operations; setting, by a user, a self-destruction time on his/her own discretion. The system comprises a storage data interface, a storage area, and a storage data switching center, and the non-volatile memory controller has a storage area analysis module and a storage mode control module. The present disclosure is based on physical properties of the non-volatile memory. Data self-destruction within a fixed time is implemented based on a fabrication process and the physical properties of the memory per se.

### FIELD

Embodiments of the present disclosure relate to the field of data self-destructing technology, and more particularly relate to a storage method and system for data self-destructing based on a physical hardware design.

### BACKGROUND

With enhancement of storage performance, data hold property and device reliability are mostly focused on, while the demand on information security is always neglected. For some time-based information or cold information, it is only required that the stored data be self-destructed within a fixed time. Generally, data self-destruction needs to be manually implemented via software or physical hardware.

The Chinese Patent CN107608915A discloses a physical self-destruction method for electronic data, wherein a low-speed explosive layer is paved on one surface of an electronic data storage medium which does not contact with a circuit, and the low-speed explosive layer is connected with an ignition device, such that ignition of the low-speed explosive by the ignition device produces a high temperature on the surface of the storage medium which causes a physical damage inside the medium, thereby achieving the objective of data self-destruction. CN105095797A discloses a physical self-destruction control circuit for an electronic data storage unit.

CN105279457A discloses a data encryption management system with a data self-destruction function, wherein data information inputted by a user is automatically fragmented first; any data reaching a certain length is partitioned as a data interval; data in each data interval are automatically encrypted with different data encryption algorithms; encryption keys of respective intervals are encrypted again; meanwhile, the user creates a password for the ciphertext encrypted with a decipherable key. Each time when the user accesses a database to browse the data, password verification is required for the to-be-browsed ciphertext; if the verification passes, the system will automatically decipher the ciphertext and meanwhile resume the initially written data information, such that the user may conveniently view data information. In the case of password verification failure or detecting a malicious crack, the system will activate the data self-destruction function to erase the data forcibly and completely. CN102571949A discloses a network-based data self-destruction method.

CN101615235 discloses a self-destruction system for memory data, comprising: a cover body for physically sealing the memory and the microcontroller; an anti-attacking circuit wound on the cover body to form a serpentine wiring arrangement; wherein one end of the anti-attacking circuit is connected to a power supply, while the other end is connected to the microcontroller and earthed via a resistor; the microcontroller is configured for detecting whether a level at the other end of the anti-attacking circuit change, and in the case of change, controlling erase of at least part of data stored in the memory; the memory is configured for storing data and being connected to the microcontroller so as to perform an erase operation on the data under the control of the microcontroller.

Flash memories are currently most extensively applied memories. The demands on flash memories in the global market dramatically increase due to the increasing demands on data storage and inexpensive memories. Flash memories have two types: NAND and NOR. The NAND flash memory offers a relatively fast erase-write speed; besides, the area of each memory cell is also relatively small; compared with the NOR flash memory, the NAND flash memory has a lower per-byte cost and a higher storage density. The NAND flash memory provides a very high cell density and thus may achieve a high storage density; besides, it also offers a fast write-erase speed.

As the feature size of flash memories cannot be further reduced, RRAM (Resistive random-access memory) as a next generation non-volatile memory has properties such as a simple structure, a fast operation speed, a low power consumption, an ease of three-dimensional integration, and a compatibility with conventional CMOS processes. Through years of development, the reliability, stability and uniformity of RRAM have been constantly approaching to the requirements of industrialization. The focus of study in the academia and industry has turned from improving RRAM devices to the large-scale integration technology.

Conventional data self-destructing technologies are all implemented external to the memory or by software programming, such that data self-destruction cannot be implemented through hardware design of the memory, and a fixed time for holding the data cannot be flexibly set.

### SUMMARY

To address the drawbacks existing in the conventional data self-destructing technologies, the present disclosure provides, in consideration of physical hardware properties of a memory (with an RRAM and a NAND flash memory as examples), a data self-destructing method based on a non-volatile memory, which may implement data self-destruction at different time and facilitate data storage; meanwhile, the present disclosure provides a system for implementing the method.

The data self-destructing method based on a non-volatile memory (NVM) according to the present disclosure comprises:

partitioning a memory module into different storage areas; setting different data hold time, wherein one hold time is specified for one storage area; causing data to be self-destructed within specific hold time by applying different processes or physical materials to different storage areas; or dynamically selecting a read/write manner for each storage area; performing different read/write operations; setting the self-destruction time by a user on his/her own discretion.

The non-volatile memory is an RRAM. Different processes or physical materials are used for different storage areas, wherein a specific process includes a film fabrication process, a material characterization technology, etc.; a physical material specifically includes an electrode layer material and a resistive storage layer material. The resistive storage layer is the core layer, which has an abundant material system, including most insulators and semiconductor materials; however, these materials have greatly different resistive properties. Currently, binary oxides are first choices, which may implement a poor device hold property from the hardware design per se, such that a desired material may be selected based on needs so as to cause the data to be self-destructed within a specific time.

The non-volatile memory is an RRAM; the read/write operation refers to implement data write in a storage area under different magnitudes of current states and different voltage pulses; by balancing the relationship between voltage magnitude and current magnitude, data self-destruction is implemented based on user requirements.

The non-volatile memory is a NAND flash memory, wherein different processes or physical materials are applied to different storage areas. A chip fabricating process includes a thin film process, a graphical process, doping and thermal processing, etc. The physical material refers to float-gating, electric resistivity of a tunneling layer and a barrier layer, physical properties of a material, and physical dimension of a device. A material with a relatively poor data hold property is selected; data write is performed based on user selection; the original data of the device is erased based a preset hold time limit.

The non-volatile memory is a NAND flash memory. Compared with an SLC device, a TLC or MLC device has a shorter data hold time. Alternatively, the read/write operation refers to writing under a high voltage so as to improve data residing error, thereby achieving the objective of data self-destruction within a fixed short time.

A data self-destructing system for implementing the method above comprises:

a data storage interface, a non-volatile memory controller, a storage area, and a data storage switching center; wherein the data storage interface is connected to a non-volatile memory controller; the non-volatile memory controller is provided with a storage area analysis module configured for partitioning different self-destruction time and managing the storage area, and a storage mode control module responsible for having work modes correspond to different storage areas; the storage data switching center is configured for implementing dynamic setting of data hold time, wherein different time hold modes are preliminarily set or dynamically adjusted during a memory read/write process.

After obtaining a data input instruction, the data that need to be saved are stored in a cache space; then, a location for data storage is determined based on the user's requirement on hold time; the data are then saved in the set storage area; next, a data write operation is performed; in the case of determining that there exists no error, data self-destruction is implemented after holding for a certain time; after the user sets the self-destruction time, different write voltages and currents are set through processing of the storage data switching center in the storage area based on needs so as to dynamically determine the hold time, thereby implementing switching to the data self-destruction time.

Hereinafter, this system will be introduced with RRAM and NAND flash memories as examples.

The present disclosure provides a method for degenerating a device hold property with respect to the RRAM device properties in conjunction with physical hardware properties of the memory, which implements the objective of data self-destruction within a fixed time. The specific method comprises: implementing degradation of the device hold property based on the process per se with respect to selection of a RRAM material. For example, selection of materials for the electrode layer and resistive memory layer. The method may further comprise: implementing data write under different magnitudes of current states, which leads to change of the data hold property, wherein for a poor hold property, low current is applied for writing, while for a good hold property, high current is applied for writing; in the case of writing under a low current, data will be easier to lose, thereby further implementing data self-destruction. The RRAM hold time is proportional to the write current (voltage), such that its working mode may be fixed in a hardware circuit. Upon read/write, the hold time of the memory may be changed based on user needs. Different voltage pulses also affect the data hold property; if the data are written under a short pulse, the data hold property will be degenerated. By balancing the relationship between the voltage magnitude and the current magnitude, data self-destruction may be implemented based on user requirements.

The present disclosure may not only be based on RRAM properties, but also may be based on NAND flash memory properties. For the NAND flash memory properties, data self-destruction is implemented based on the time limit of use in conjunction with hardware design of the device. The method specifically comprises: selecting a material with a relatively poor data hold property; performing data write in an actual system based on user selection; setting a hold time limit; and erasing the original data of the device. The method specifically further comprises: degenerating a tunneling oxide layer by a high electrical field stress induced under a high voltage operation, which produces a voltage-induced tunneling layer leakage current, wherein with constant shrinkage of the tunneling layer, the current leakage becomes more and more serious, thereby causing a series of reliability issues such as hold property degeneration and read crosstalk, etc. In a specific embodiment, write under a high voltage will raise the data residing error, thereby achieving the objective of data self-destruction within a fixed short time. During the process of erasing the memory unit, the storage cells under the MLC mode and the TLC mode are easily degenerated; therefore, the memory device-based data self-destruction according to the present disclosure may be based on a multiple valued memory, thereby globally enhancing the working efficiency of the memory

The present disclosure is based on physical properties of a non-volatile memory. Data self-destruction within a fixed time is implemented based on a fabrication process and the physical properties of the memory per se. Data self-destruction within a fixed time is implemented by degenerating the device hold property; in this way, data destruction at different time points may be implemented based on user needs, thereby facilitating data storage.

### BRIEF DESCRIPTION OF THE DRAWINGS

FIG. 1 is a structural schematic diagram of RRAM;

FIG. 2 is a resistance switching property diagram of the RRAM;

FIG. 3 is an I-V (current-voltage) property diagram of RRAM under different hold currents;

FIG. 4 is a relationship diagram of RRAM voltage pulse duration and voltage magnitude with respect to hold properties;

FIG. 5 is a structural schematic diagram of a NAND flash memory;

FIG. 6 is a schematic diagram of various different action modes of the NAND flash memory;

FIG. 7 is a schematic diagram of state switching between various different memory cells of the NAND flash memory;

FIG. 8(a) shows selection modes for a one-hour self-destruction area, a one-day self-destruction area, and a normal area of an area selection mode of a memory chip;

FIG. 8(b) shows a multi-area selection mode of an area selection mode of a memory chip;

FIG. 9 shows an example based on a data self-destruction mode; and

FIG. 10 shows an example based on dynamic selection of a data self-destruction storage area.

### DETAILED DESCRIPTION OF EMBODIMENTS

The present disclosure intends to devise a data self-destruction device. The present disclosure enables selectively holding an information content for a fixed time. The specific implementation thereof is to design based on physical hardware, rather than software. The present disclosure implements data self-destruction based on hardware design, wherein a NAND flash memory and a RRAM are taken as examples.

The data self-destructing method based on a non-volatile memory according to the present disclosure comprises: partitioning a memory module into different storage areas; setting different data hold time; applying different processes or physical materials to different storage areas, such that the data are self-destructed within a specific hold time; or performing different read/write operations; setting a self-destruction time by the user on his/her own discretion; and dynamically selecting a read/write manner for each area, thereby implementing data self-destruction.

With the NAND flash memory and the RRAM as examples, different storage areas are set, and the material used for each layer of the device and the fabrication process of the device are determined dependent on different holding time. Data self-destruction is implemented based on the physical properties of the device. With the NAND flash memory as an example, data are written under a high voltage. Selecting MLC or TLC will degenerate the data hold property, thereby achieving self-destruction of the data within a short time. With the RRAM as an example, data are written under a short-pulse low current, which will degenerate the data hold property, thereby achieving self-destruction of the data within a short time. As to designing of storage areas of the memory, the memory may be partitioned into fixed areas with fixed self-destruction time; or, the data write manner may be changed via a data switching center of the memory so as to adjust the hold time.

Hereinafter, the present disclosure will be described in detail with RRAM and NAND flash memories as examples.

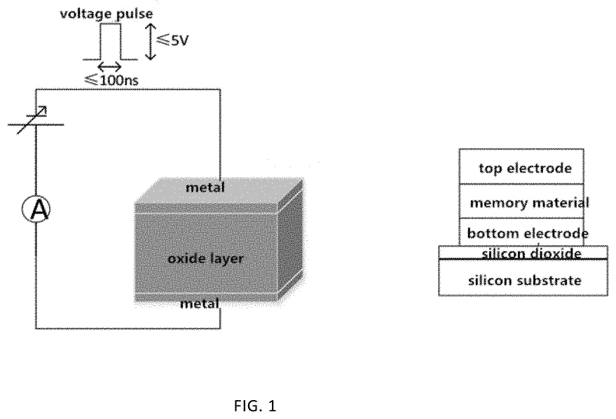

FIG. 1 shows a structure of an RRAM. The material structure of the RRAM includes an upper electrode, a lower electrode, and a resistive functional layer, wherein the resistive functional layer material is the core. Different selections of material combinations cause the performance parameters of the device to vary greatly. Abundant materials are available for the resistive function layer, e.g., a multiplex oxide, a solid-state electrolyte material, an organic material, and a binary oxide, etc. A specific process includes a film fabrication process, a material characterization technology, etc. With optimization of semiconductor fabrication processes, change of materials, and variation in device structure designs, data self-destruction within a specific time may be implemented through the materials, which is more economical. The materials and processes may be used flexibly based on different hold time and different storage characteristics.

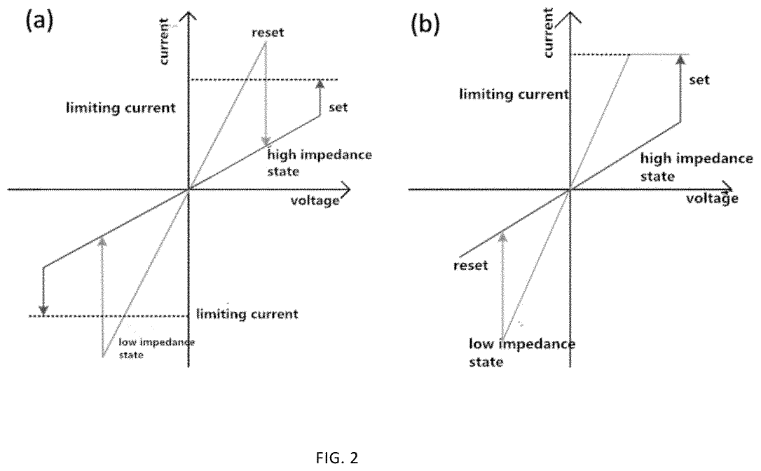

FIG. 2 illustrates a resistance switching property of the RRAM. The RRAM is reversibly switchable between high and low impedance states based on the resistance of the film material under electrical excitation, thereby implementing data storage. The RRAM has two operation manners: single polarity and dual polarities. Under the action of an appropriate electrical signal, resistance of the device will switch between a high impedance state and a low impedance state, thereby implementing “0” and “1” storage. To avoid the device from being permanently broken down during the SET process, a limiting current needs to be applied, where the magnitude of the limiting current will affect the hold property of the RRAM.

Three different areas may be partitioned based on the I-V property: where the current and the voltage have a linear relationship; where the current is proportional to the square of the voltage; where the current rapidly increases with the voltage. Therefore, in actual applications, the hold property of data will be degenerated under a relatively large voltage. By balancing the relationship between the voltage and the current, the data hold property will be degenerated when the current is relatively small; therefore, desired values of the current and the voltage may be determined based on the relationship between the current and the voltage.

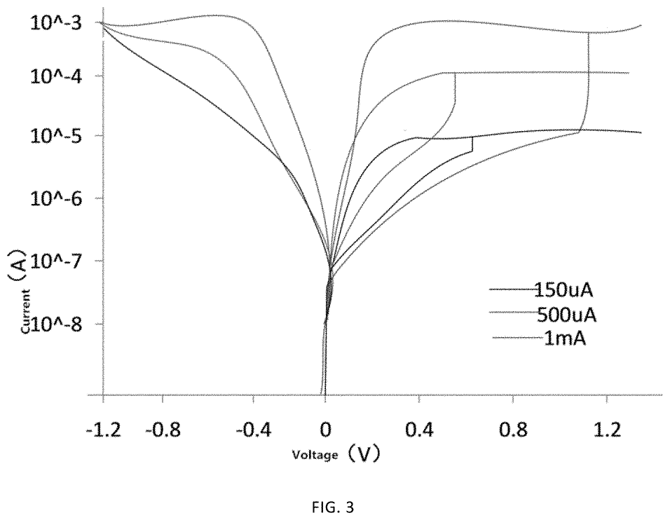

FIG. 3 shows an I-V (current-voltage) property diagram of RRAM under different hold currents. RRAM has attracted a great deal of attention due to its simple structure, fast speed, and high density. An object of the present disclosure is to degenerate the hold property of the RRAM so as to cause the data to be self-destructed. In actual applications, the uniformity of the operating current and performance should be balanced. In the large-current state, the device has a better performance; on the contrary, in the small-current state, the device has a poor hold property.

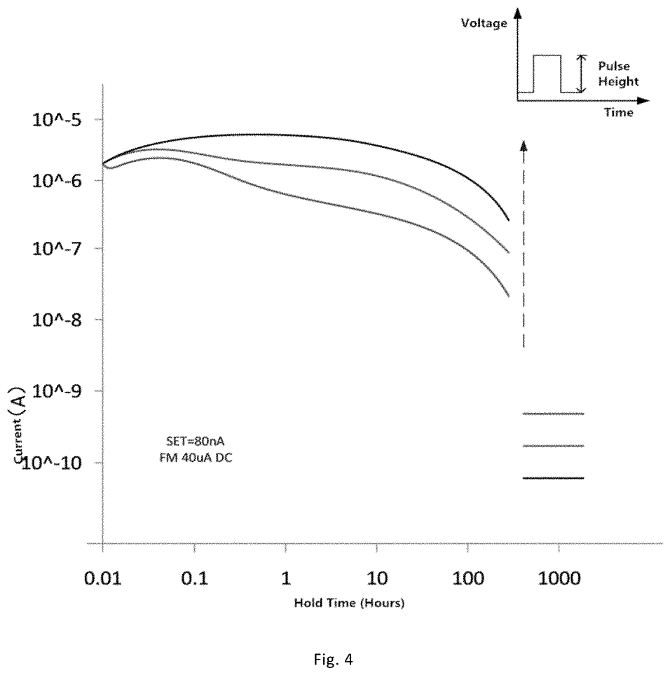

FIG. 4 is a relationship diagram of the RRAM voltage pulse duration and voltage magnitude with respect to the hold property. If the time for the high impedance-state resistor to apply a voltage to reset or the time for the low impedance-state resistor to apply a voltage to set is too long, or the voltage pulse is too high, the hold property of the impedance-state resistor will be degenerated, and even worse, an impedance-state reversal error would occur. This phenomenon will not only cause write interference, but also will cause energy waste. The present disclosure may write data in a short pulse according to user needs; then, the device hold property will be degenerated; by balancing the voltage magnitude and the current magnitude, the cost will be lowered.

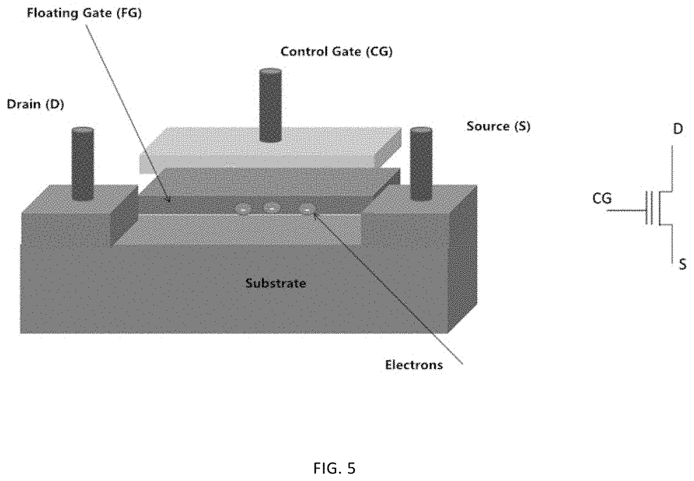

FIG. 5 is a structure of a NAND flash memory. A conventional floating-gate memory comprises: a substrate, a source, a drain, a tunneling layer, a floating gate, a barrier layer (inter-polycrystal dielectric layer), and a control gate. With change and optimization of processes (including thin film process, graphical process, doping, and thermal processing, etc.), the floating-gate may be replaced with other materials; the tunneling layer and the barrier layer materials may also be changed; in this way, the performance and reliability of the NAND flash memory may be changed.

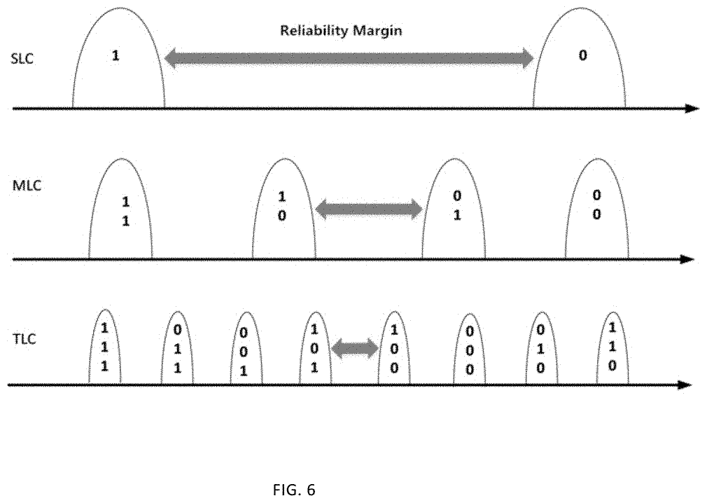

FIG. 6 shows various action modes of the NAND flash memory. The current memory action modes mainly include three read/write modes: single-level cell, multi-level cell (MLC), and triple-level cell (TLC); while quad-level cell (QLC) also has applications in 3D flash memories. The SLC refers to one bit per cell, which has characteristics such as a fast erase-write speed, a large data reading window, an extremely low byte misread rate, and a long erase-write lifetime; however, its price is very high. MLC refers to two bits per cell; with increase of the density, the cost of data storage on an MLC component is lowered, but the erase speed drops; besides, the service life is normal. The TLC refers to triple bits per cell, which has a slow erase-write speed and a short erase-write lifetime; the low cost of the TLC is very suitable for the consumer market having limited writes. The QLC refers to four bits per cell, which has a storage density 16 times of the SLC mode; however, it has a very slow erase-write speed; besides, its data misread rate is high and the erase-write times is very limited. The present disclosure exactly leverages the MLC and the TLC due to their inexpensiveness and limited data erase-write times.

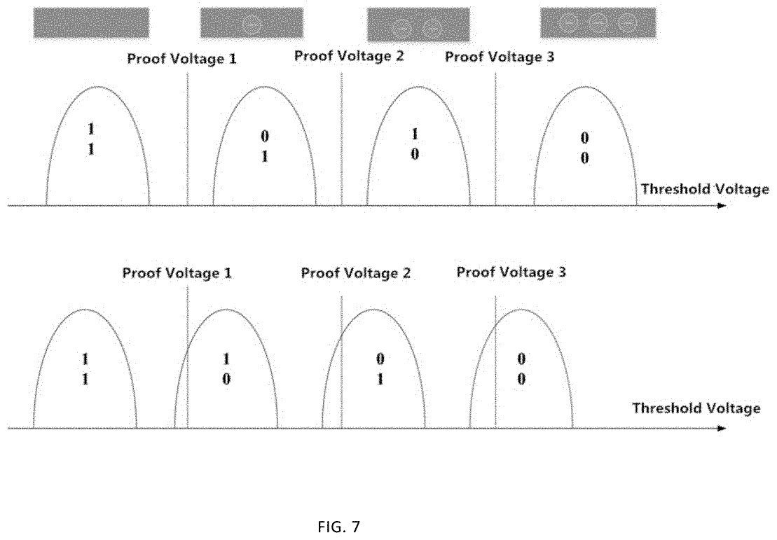

FIG. 7 is a schematic diagram of state switching between various different memory cells of the NAND flash memory. Generally, in a high voltage operation mode (programming/erasing mode), the tunneling layer of the device will be degenerated. A data residing error easily occurs to a memory cell in a state with a relatively high threshold voltage (right side), particularly the “01” state which indicates the highest threshold voltage and “00” state the second highest voltage state. The data residing error does not occur in the erase state “11” at the lowest threshold voltage side. Therefore, from the perspective of the user of the NAND flash memory, if the proportion of “01” state in the storage cells is raised by certain data processing means, the data residing errors for the NAND flash memory will increase.

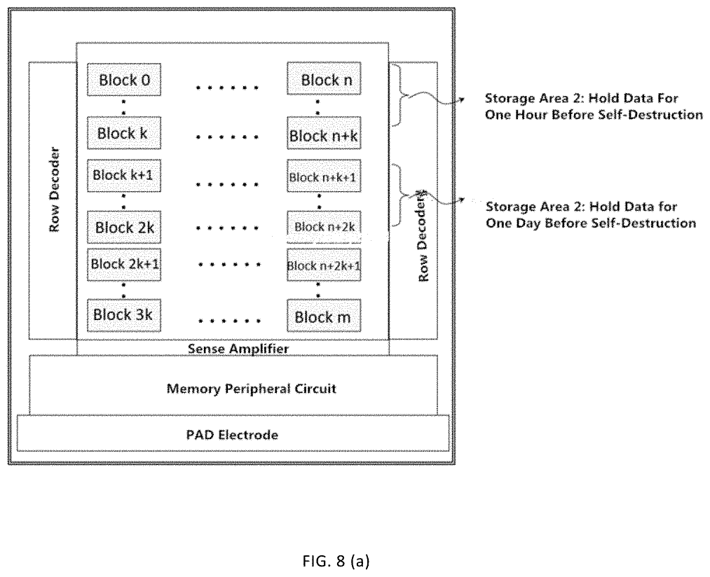

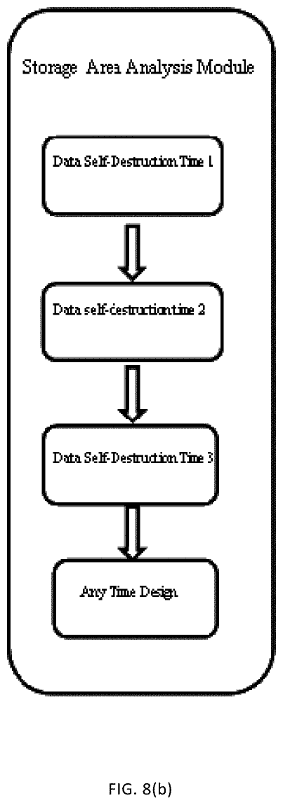

FIG. 8 is an area selection mode of a memory chip. A single memory chip has a plurality of blocks, which may be divided into three portions. Several blocks are selected therefrom as specific areas for self-destruction within a fixed time. FIG. 8(a) only illustrates a one-hour self-destructing area, a one-day self-destructing area, and a normal area. A user may divide the memory chip into a plurality of areas based on his own needs, e.g., FIG. 8(b).

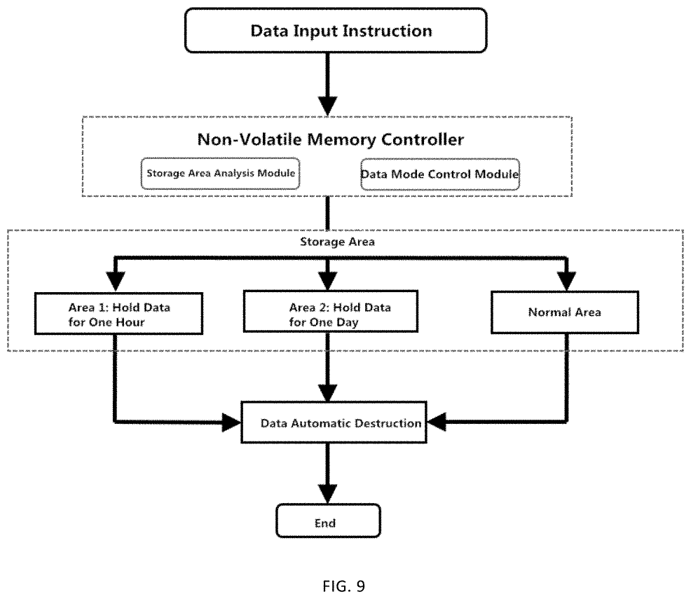

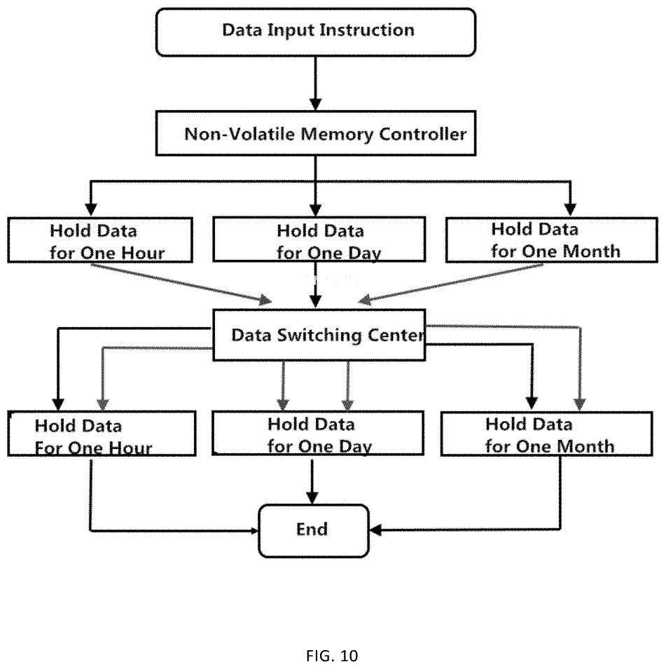

FIGS. 9 and 10 illustrate a data self-destructing system based on a non-volatile memory (NVM) according to the present disclosure, which comprises: a storage data interface, a non-volatile memory controller, a storage area, and a data storage switching center. the non-volatile memory controller is provided with a storage area analysis module configured for partitioning different self-destruction time and managing the storage area, and a storage mode control module responsible for having work modes correspond to different storage areas; the storage data switching center is configured for implementing dynamic setting of data hold time, wherein different time hold modes are preliminarily set or dynamically adjusted during a memory read/write process.

FIG. 9 illustrates an example of a data self-destructing system. After obtaining a data input instruction, the data that need to be saved are stored in a cache space; then, a location for data storage is determined based on the user's requirement on hold time; the data are then saved in the set storage area; next, a data write operation is performed; in the case of determining that there exists no error, data self-destruction is implemented after holding for a certain time. When the user sets the self-destruction time, different write voltages and currents are set through processing of the storage data switching center in the storage area based on needs so as to dynamically determine the hold time. in this way, switching of the data self-destruction time is implemented.

FIG. 10 shows an example of dynamically selecting a data self-destruction storage area. When the user sets the self-destruction time, a read/write manner may be dynamically determined for the storage area according to needs; a desired action mode is set through processing in the storage area by the storage data switching center, thereby implementing switching of the data self-destruction time.

Those parts not described in detail in the present disclosure are all prior arts.

What is claimed is:

1. A data self-destructing method based on a non-volatile memory, comprising: partitioning a memory module into different storage areas; setting different data hold time; applying different processes or physical materials to different storage areas, such that the data are self-destructed within a specific hold time; or dynamically selecting a read/write manner for each storage area; performing different read/write operations; setting, by a user, the self-destruction time on his/her own discretion.

2. The data self-destructing method based on a non-volatile memory according to claim 1, wherein the non-volatile memory is RRAM; different processes or physical materials are applied to different storage areas, so as to implement degenerating a device hold property from the process per se and cause the data to be self-destructed in the specific time.

3. The data self-destructing method based on a non-volatile memory according to claim 1, wherein the non-volatile memory is an RRAM; the read/write operation refers to implementing data write in the storage area under different magnitudes of current states and different voltage pulses.

4. The data self-destructing method based on a non-volatile memory according to claim 1, wherein the non-volatile memory is a NAND flash memory; different processes or physical materials are applied to different storage areas, which means selecting a material with a relatively poor data hold property, so as to implement data writing based on user selection and erase the original data of the device based on a set hold time limit.

5. The data self-destructing method based on a non-volatile memory according to claim 1, wherein the non-volatile memory is a NAND flash memory; the read/write operation refers to writing under a higher voltage and enhancing a data residing error, thereby achieving an objective of self-destructing data within a fixed short time.

6. A data self-destructing system based on a non-volatile memory, comprising: a data storage interface, a non-volatile memory controller, a storage area, and a data storage switching center; wherein the non-volatile memory controller is provided with a storage area analysis module configured for partitioning different self-destruction time and managing the storage area, and a storage mode control module responsible for having work modes correspond to different storage areas; the storage data switching center is configured for implementing dynamic setting of data hold time, wherein different time hold modes are preliminarily set or dynamically adjusted during a memory read/write process.
